(19) United States
(12) Patent Application Publication
(10) Pub. No.: US 2004/0001455 A1
(43) Pub. Date: Jan. 1, 2004

(54) Method and system for identification of digitally signed messages in a telecommunication system

(75) Inventors: Mikko Matto, Espoo (FI); Jukka Liukkonen, Helsinki (FI); Henna Pietilainen, Espoo (FI); Veera Lehtonen, Helsinki (FI)

Correspondence Address: COHEN, PONTANI, LIEBERMAN & PAVANE, Suite 1210, 551 Fifth Avenue, New York, NY, 10176, US

(73) Assignee: Smarttrust Systems Oy

(21) Appl. No.: 10/245,736

(22) Filed: Sep. 17, 2002

(30) Foreign Application Priority Data
Mar. 24, 2000 (FI) 20000695
Mar. 20, 2001 (WO) PCT/FI01/00279

(51) Int. Cl. H04Q 7/00

(52) U.S. Cl. 370/328

(57) ABSTRACT

A method and system for identifying digitally signed messages in a telecommunication system that includes a telecommunication network, a mobile station connected to the telecommunication network and which has an associated subscriber identity module, a network server connected to the telecommunication network, and a database connected to the network server and which stores a list of identification numbers for each mobile station. When a message is to be sent from, for example, a mobile station to the network server, a first authentication unit in the mobile station attaches to the message a message identification number that has been increased or incremented from the number attached to a previous message sent from the mobile station. The message with the attached identification number is then sent to a second authentication unit, as at the network server, in which the identification number is checked against the stored list of identification numbers to determine whether the message has already been received and, if not, the message is accepted.

### BACKGROUND OF THE INVENTION

1. Field of the Invention

The present invention relates to telecommunication systems. In particular, the invention is directed to a method and system in which an identification number is attached to a message to be sent from one to the other of a mobile station and a network server, and wherein a list of message identification numbers stored or available at the receiving station or server is used to determine whether the received message should be accepted.

2. Description of Related Art

The digital signing of short messages is becoming increasingly common. A digital signature is an electronic signature that enables the sender of the signed message to be identified with certainty. A digital signature may also be used to determine whether the sent message has changed during the data transfer and to automatically provide a time stamp in the message. Digital signing of a message does not, however, generally result in encryption of its contents, so that if the message includes sensitive information it may additionally be encrypted using, for example, a public key arrangement such as the Rivest-Shamir-Adleman (RSA) standard.

The short message service of telecommunication systems enables a user to send short text-based messages that contain, in typical implementations, up to 160 characters in the message. The transmission of such messages does not require that the intended recipient mobile station be switched on. If the recipient mobile station cannot be reached, the message is saved to the short message service center, which will store the message for several days; when the intended recipient mobile station is thereafter activated in the range or area of the mobile network, the message is then transmitted from the short message service center to the mobile station. Messages may be transmitted either within the same cell or, by means of the roaming feature of the mobile station, to other cells. In their transfer from the sender to the recipient, short messages are typically transmitted through several components of the telecommunication network, which may result in message transfer delays, message loss or disappearance and/or changes in the order of receipt of messages. Short messages may also be transmitted to other devices, such as digital telephones or as e-mail messages to data terminals and the like.

The transfer or exchange of a message to be transmitted in a telecommunication system can take place in any of four different ways: as a notification of the server, a notification of the mobile station, a PUSH service or a PULL service. In a server notification, the server sends to the mobile station a message to which no response is expected. Correspondingly, in a mobile station notification the mobile station sends to the server a message to which the mobile station has no expectation of a response. In a PUSH service, on the other hand, the server sends to the mobile station a message to which the server expects a response, and the PUSH service may continue further with another message thereafter sent by the server. Likewise, in a PULL service the mobile station sends to the server a message to which the mobile station expects a response and, as in the PUSH service, the PULL service may be continued by the subsequent or responsive sending of another or further message from the mobile station to the server.

It should be noted that the message channel used to send messages in a mobile communication system has a very low bandwidth and transmission rate. In addition, the sender and the recipient of a message do not have a reliable common clock.

One problem that is encountered in the implementation of short messaging arrangements lies in the identification of particular messages, with the related problem of recognizing duplicate messages or messages sent or received too late or in an otherwise untimely manner. Digitally signed messages are commonly used for single or one-time transactions, such as the payment of bills; such situations present the risk that an extraneous entity could store the message and then resend it at a later time to fraudulently gain an economic advantage or profit, a scheme sometimes referred to as a repetition attack. It is also possible that, despite proper operation of the data transmission system, messages may be unintendedly duplicated or repeated in the course of transmission; when this occurs, however, the message duplication or repetition tends to be more obvious when the message arrives at its destination. Error correction may also be performed on a message based on the sending of several messages.

One solution to these problems has been developed. Prior to digital signing of a message, a time stamp used to identify the time of transmission is attached to the message. When that time stamp is thereafter compared to the clock of the recipient, it is possible to determine whether the message is merely a duplicate and, of perhaps greater importance, whether it has been received too late or beyond a predetermined or acceptable time window; duplicate messages and those received too late are rejected. This known method is, however, rather cumbersome to implement in a mobile station since it requires accurate synchronization of the respective clocks of the sender and recipient of the message. Time stamps are also not entirely reliable, particularly where duplicate copies of a message are generated very fast. Such rapidly generated duplicate messages may receive the same time stamp, in which case the correct transmission order of the messages cannot be determined.

### OBJECTS AND SUMMARY OF THE INVENTION

It is accordingly the desideratum of the present invention to eliminate, or at least significantly alleviate, the drawbacks and deficiencies of currently known or available systems and methods, as for example those discussed hereinabove.

It is a particular object of the invention to provide an unusually simple and advantageous system and method for the identification, both in a mobile station having a restricted amount of memory and calculation capacity and in a server of a telecommunication network, of messages transmitted through the network.

It is a further object of the invention to provide such a system and method for recognizing or identifying duplicates of digitally signed messages and signed messages that have arrived too late, both of which should be rejected because the included information may be invalid or incorrect.

The present invention is, inter alia, directed to a method by which such a message is first saved. Prior to sending of a message, an identification number that serves as an identifier and individualizer of the message is attached to the message by a first authentication unit. The first authentication unit operatively assures that the identification number to be attached is larger than the identification number that was attached to any preceding message sent from the mobile station, as for example by incrementing or otherwise increasing the identification number that was attached to the most recently sent message. The message and its attached identification number are then digitally signed and communicated, via the telecommunication network, to a second authentication unit in which the identification number attached to the received message is compared to the largest or uppermost or highest identification number in a listing or table of identification numbers that is stored by the second authentication unit. If the identification number attached to the message is found to exceed that largest identification number in the stored listing, then the listing of identification numbers is updated with the new message identification number and the received message is accepted. If, on the other hand, the identification number attached to the message is less than the lowest or smallest identification number in the stored listing of identification numbers, then the message is deemed to have been received too late and is rejected. Finally, if the identification number attached to the message falls between the smallest and largest identification numbers in the stored listing, then the stored listing of identification numbers is consulted to determine whether the newly-received message identification number already appears in the stored listing, which would indicate that the message is a duplicate of one that has already been received since the listing contains the identification numbers of all messages theretofore received. Thus, if this final comparison reveals that the message has not yet been received, the stored listing of identification numbers is updated to now include the identification number attached to the newly-received message and that message is accepted; otherwise, the message is rejected.

To identify messages, a first authentication unit must be provided in either the mobile station or the network server, i.e. in whichever of the two generates the message identification number and attaches it to the message at the point of transmission. The first authentication unit must also have the capability of recognizing if the identification number to be attached to a message has grown too large for use or processing in the system, in which case the first authentication unit modifies its operation so that it, for example, no longer increments or increases the previous message identification number to be attached to the new message to be sent, and/or so that it halts further operation. A second authentication unit is provided in the server of the mobile communication system, or in the mobile station (i.e. in the receiver of the message), for operatively identifying the received message by comparing the attached identification number with the mobile station-specific individualized stored listing of identification numbers.

In one currently-contemplated implementation, the user of the mobile station can pay a bill using his or her mobile station by sending a digitally signed short message to which an identification number has been attached. The user writes or places the information needed to pay the bill in the short message and then sends the short message to the server, at which the message is identified in accordance with the invention.

As compared to prior art systems and methods, the present invention advantageously enables the prompt and ready identification, among digitally signed messages, of duplicate messages and of messages received too late (i.e. beyond a predetermined time window) for acceptance. The inventive system and method may, furthermore, be employed in mobile stations and the like which have only a limited or restricted amount of memory and available processing power. The invention also advantageously prevents the successful use of repetition attacks.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1 is a block diagrammatic representation of a system implementation of the present invention;

FIG. 2 is a flow chart of a method in accordance with the invention;

FIGS. 3a, 3b, 3c and 3d depict by way of example the information presented on a display screen of a user's mobile station in accordance with an illustrative implementation of the inventive system and method;

FIG. 4 depicts a stored listing of identification numbers in accordance with the invention;

FIG. 5 is a diagrammatic representation of a telecommunication system implemented in accordance with an embodiment of the invention; and

FIG. 6 is a diagrammatic representation of another telecommunication system implemented in accordance with the invention.

### DETAILED DESCRIPTION OF THE CURRENTLY PREFERRED EMBODIMENTS

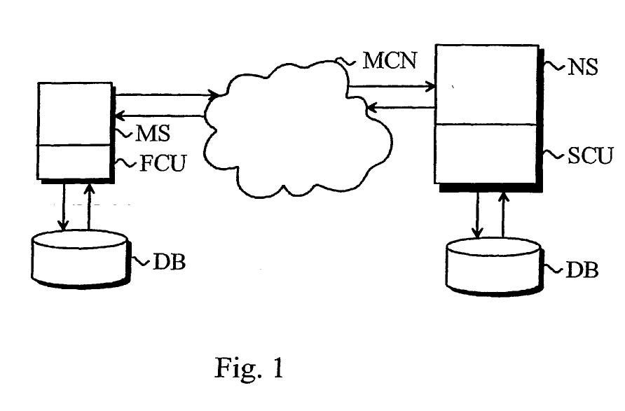

FIG. 1 illustrates a system implemented in accordance with the invention. A mobile station MS includes a first authentication unit FCU, which may by way of preferred example be disposed in or on the subscriber identity module (SIM) of the mobile station. The mobile station MS is connected to a network server NS via a telecommunication network MCN. Network server NS includes a second authentication unit SCU which is connected to a database DB. Database DB contains a stored list, for each mobile station of or associated with the network, of identification numbers of or that have been attached to theretofore received messages from the each mobile station. The second authentication unit SCU processes each received message sent by the mobile station and confirms the reliability of the message by consulting the stored list of identification numbers. The message is deemed to be incorrect or unreliable, and is therefore rejected, if it is determined to have arrived too late or to be a duplicate message.

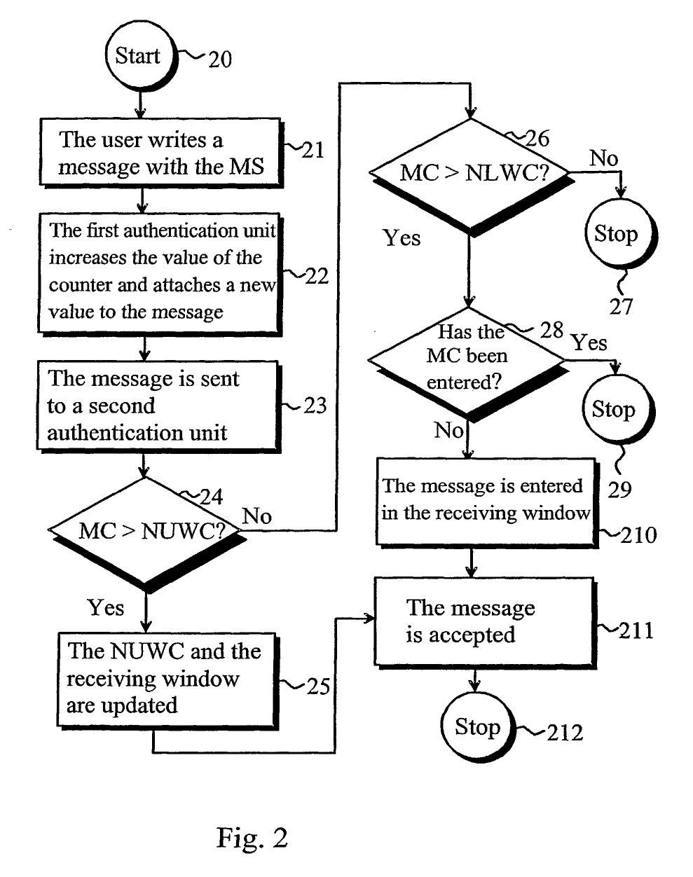

At the start of the inventive method as shown in the flow chart of FIG. 2, the user writes or otherwise generates or creates a message in or using the mobile phone (block 21). Before sending the message, the first authentication unit FCU generates an identification number for the message by incrementing or increasing the identification number that was assigned to, for example, the previous message most recently-sent from the mobile station, and attaches the resulting new identification number MC to the message to be sent (block 22). The message is then digitally signed and transmitted or sent to the second authentication unit SCU (block 23). The identification number MC of the received message is compared, by the second authentication unit SCU, to the highest or largest or uppermost number NUWC contained in the stored list of identification numbers maintained in the network server for that user's mobile phone (block 24). If the identification number of the received message is determined to be larger than the highest stored number in the list, then the list is updated to additionally include the larger identification number of the newly-received message (block 25). One contemplated manner of implementing the stored list of identification numbers is through the use of bit registers in which a separate bit is used to mark whether the message has previously or already been received. If the result of the query at block 25 indicates that the message identification number MC is not greater than the largest number NUWC already in the stored list, then the received message identification number is compared to the smallest number NLWC stored in the list of identification numbers by determining whether the identification number MC is greater than the smallest stored number NLWC (block 26). A negative response to the block 26 query, i.e. a finding that the received message identification number MC is less than (or equal to) the smallest message number NLWC stored in the list of identification numbers, indicates that the message may have arrived too late and the message is therefore rejected (block 27). A positive response to the block 26 query, on the other hand, indicates that the message identification number MC falls within the range spanning the smallest and largest stored identification numbers. At block 28, therefore, the message identification number MC which has been found to fall within the stored range of identification numbers is then compared to the identification numbers already stored in the list to determine whether a message having the same identification number has already been received. If so, the message is deemed to be a duplicate message and is rejected (block 29). Where, on the other hand, it is determined at block 28 that the message identification number MC has not previously been entered in the stored list of numbers, the message number MC is added to the list (block 210) and the message is accepted (block 211).

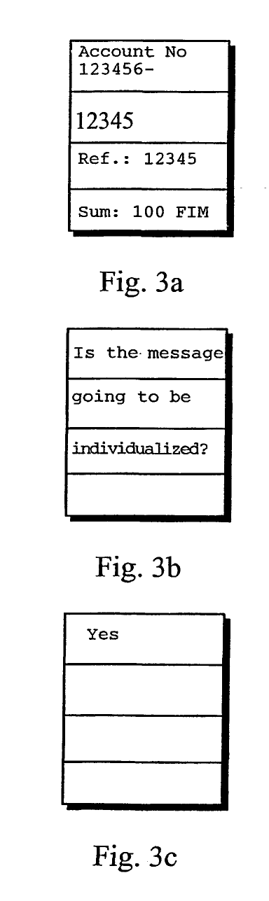

FIGS. 3a to 3d depict by way of example the information displayed on a user's mobile station display screen in an illustrative implementation of the inventive method. The user writes or enters into the mobile station the information needed to pay a particular bill; FIG. 3a shows this information as it might appear on the display of the user's mobile station. Before digital signing of the message, the user is asked (FIG. 3b ) whether the message is to be individualized. The user responds by, as shown in FIG. 3c, agreeing to individualizing of the message, as a result of which an individualizing identification number is attached to the message. The message is then digitally signed and transmitted to the network server via the data transmission network. Finally, as depicted in FIG. 3d the user is informed that the message has been successfully sent.

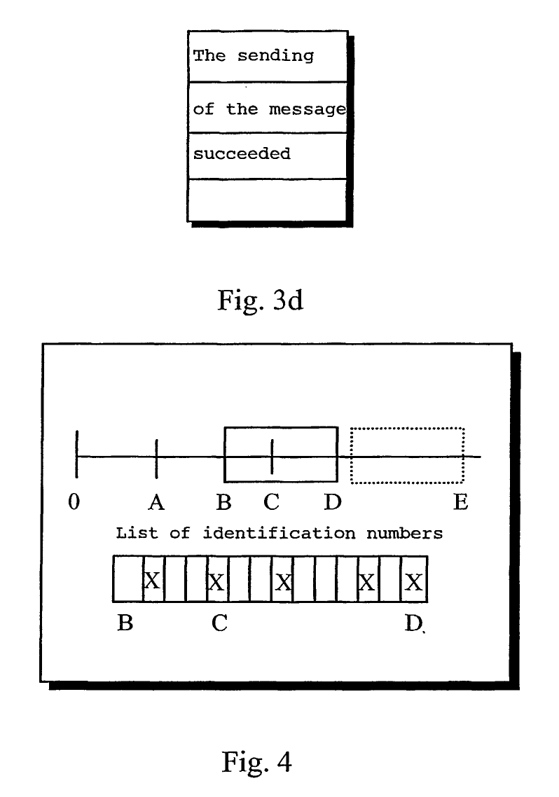

FIG. 4 shows a typical stored list of identification numbers maintained by the second authentication unit in accordance with the invention. The upper line segment in FIG. 4 denotes a range of possible message identification numbers. The current acceptable identification number range is indicated by the solid line rectangle covering the range B to D. Thus, the identification number of message B is the smallest or lowermost number in the list and is therefore the minimum acceptable message identification number for a newly-received message. Because the identification number of message A is less than the identification number of message B, message A has arrived too late and will be rejected. The identification number of message D is the largest or uppermost acceptable message identification number in the list for use in evaluating newly-received messages. The identification number of message C is within the acceptable range of stored identification numbers, but a newly-received message C will not be accepted because its identification number is already present in the list, as indicated in the lower portion of FIG. 4 at which points marked with an X indicate the identification numbers of previously-received messages. Thus, message C is identified as a duplicate of a message that has already been received. The identification number of message E is greater than the highest stored identification number (i.e. of message D). Accordingly, when message E is received the list of identification numbers is updated so that the identification number of message E thereafter becomes the largest or uppermost identification number of the updated list for use in evaluating the acceptability of subsequently-received messages. In updating of the list, the range of acceptable identification numbers is moved or advanced along the numerical range, as indicted by the dotted line rectangle in FIG. 4, to eliminate from the list the identification numbers of the oldest received messages.

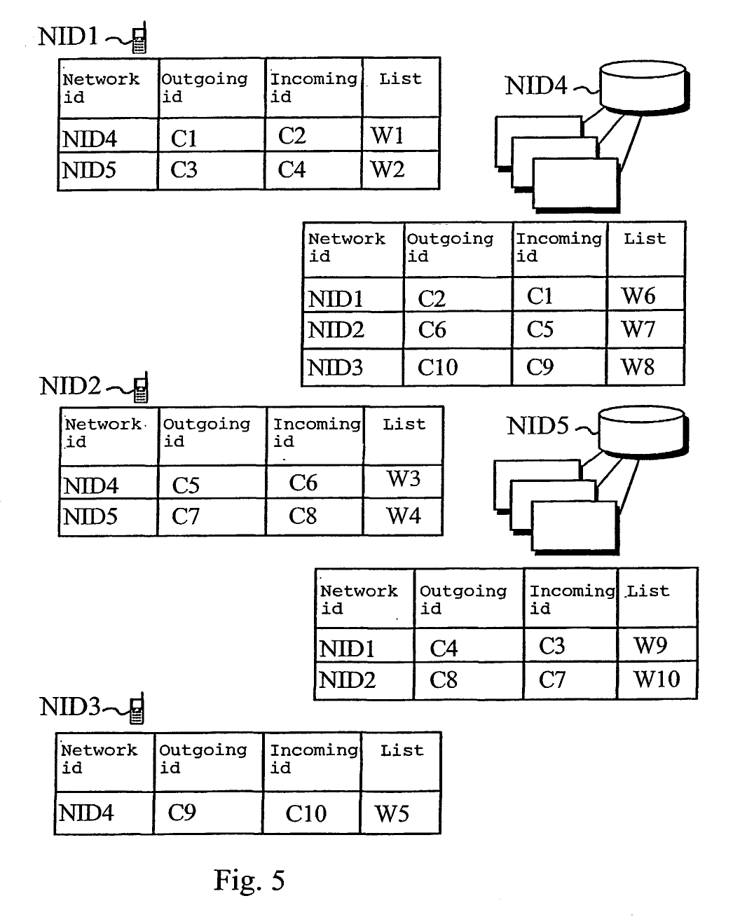

FIG. 5 diagrammatically represents an embodiment of a telecommunication system implementation in accordance with the invention. The telecommunication system there illustrated comprises mobile stations NID1, NID2, NID3 and databases NID4, NID5. Stored in the mobile station NID1 is a database that includes a network identifier (Network ID), an identifier of an outgoing message, an identifier of an incoming message, and a listing of the identification numbers of messages that have theretofore been received. The Network ID is an unambiguous number used to identify the particular device—in this case the mobile station NID1—in the telecommunication network. In FIG. 5, the outgoing identifier is an identifier that is to be attached to an outgoing message and, similarly, the incoming identifier is the identification number of an incoming message. These identification numbers may for example be formed of 16 data bits. The server of the telecommunication network contains such a database for each mobile station of the network for use in identifying and validating messages sent to the server from each mobile station. The system is symmetric, so that in accordance with the invention it is possible to identify both messages sent from a mobile station to the server and messages sent from the server to each mobile station.

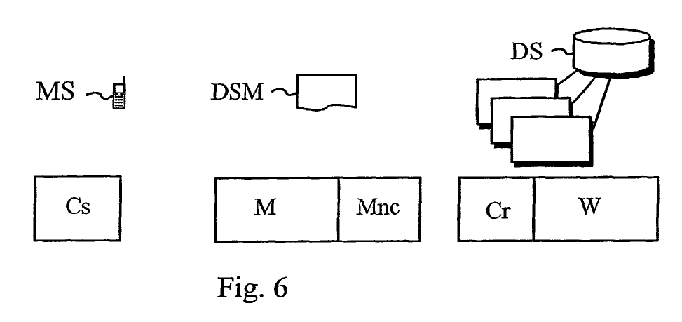

In the embodiment depicted in FIG. 6, each network element of the illustrated telecommunication system includes information for identification of messages. Thus, the mobile station MS stores an a-bit identification number CS that contains the value of the identifier of the last-sent message. A digitally signed message DSM itself comprises the content of the message M and an identification number MNC. Stored in the server DS is an a-bit identification number CR that contains the largest message identification number theretofore received by the server from the mobile station MS, as well as a b-bit list of identification numbers W that stores the status of an already-received message identification number B of a message from the station MS. The b-bit list of identification numbers W may for example be implemented as a bit field in which a “1” bit denotes that the subject message has been received and a “0” bit indicates that the message has not been received.

While there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for identification of a digitally signed message in a telecommunication system that includes a telecommunication network, a mobile station connected to the telecommunication network and that includes a subscriber identity module, a network server connected to the telecommunication network, and a database connected to the network server and which comprises a list of identification numbers, said method comprising the steps of:
generating, in the mobile station, a message to be sent from the mobile station to the network server over a connection established between the mobile station and network server;
incrementing, in a first authentication unit, a message identification number;
attaching the incremented message identification number to the generated message;
sending the message with the attached incremented message identification number to a second authentication unit;
comparing, at the second authentication unit, the attached incremented message identification number to the list of identification numbers stored in the database connected to the network server, said list comprising identification numbers attached to messages previously received by the second authentication unit from the mobile station;
accepting, at the second authentication unit, the received message if the received message has not already been received by the second authentication unit; and
accepting, at the second authentication unit, the received message if the incremented identification number is determined by said comparing step to be greater than a largest identification number of the list of identification numbers stored by the database.

2. The method of claim 1, wherein the first authentication unit is located in one of the mobile station and the subscriber identity module, and the second authentication unit is located in the network server.

3. The method of claim 1, further comprising the step of updating the stored list of identification numbers, if said comparing step determines that the incremented identification number of the received message is greater than the largest identification number of the list of identification numbers stored by the database, so that the incremented identification number thereafter comprises the largest identification number of the list of identification numbers stored by the database.

4. The method of claim 1, wherein said step of accepting the received message if the received message has not already been received by the second authentication unit comprises accepting the received message if said comparing step determines that (i) the incremented identification number of the received message is greater than a smallest identification number of the list of identification numbers stored by the database, and (ii) the incremented identification number of the received message is smaller than the largest identification number of the list of identification numbers stored by the database, and (iii) the incremented identification number is not already stored in the list of identification numbers stored by the database.

5. The method of claim 1, further comprising the step of updating the list of identification numbers stored by the database if the received message is accepted at the second authentication unit.

6. The method of claim 1, wherein said step of sending the message comprises sending the message in a GSM mobile communication system.

7. The method of claim 1, wherein said step of sending the message comprises sending the message via a short message service.

8. The method of claim 1, further comprising the step of digitally signing the message prior to said sending of the message to the second authentication unit.

9. The method of claim 1, wherein the first authentication unit is programmed to halt operation if said incrementing of the message identification number results in an incremented identification number of greater than a predetermined size.

10. The method of claim 1, wherein the first authentication unit is located in the subscriber identity module.

11. A method for identification of a digitally signed message in a telecommunication system that includes a telecommunication network, a mobile station connected to the telecommunication network and that includes a subscriber identity module, a network server connected to the telecommunication network, and a database connected to the network server and which comprises a list of identification numbers, said method comprising the steps of:
preparing a message to be sent between the mobile station and the network server over a connection established between the mobile station and network server;
incrementing, in a first authentication unit located in the network server, a message identification number;
attaching the incremented message identification number to the prepared message;
sending the message with the attached incremented message identification number to a second authentication unit located in one of the mobile station and the subscriber identity module;
comparing, at the second authentication unit, the attached incremented message identification number to the list of identification numbers stored in the database connected to the network server, said list comprising identification numbers attached to messages previously received by the second authentication unit from the mobile station;
accepting, at the second authentication unit, the received message if the received message has not already been received by the second authentication unit; and
accepting, at the second authentication unit, the received message if the incremented identification number is determined by said comparing step to be greater than a largest identification number of the list of identification numbers stored by the database.

12. A system for identification of a digitally signed message in a telecommunication system that includes a telecommunication network, a mobile station connected to the telecommunication network and that includes a subscriber identity module, a network server connected to the telecommunication network, and a database connected to the network server and which comprises a list of identification numbers of the mobile station, and wherein a connection is established between the mobile station and the network server for transmission of a digitally signed message between the mobile station and network server, said system comprising:
a first authentication unit comprising a generator for generating an identification number for a message to be transmitted and for attaching the generated identification number to the message; and
a second authentication unit comprising an authenticator for identifying a received digitally signed message having an attached generated identification number and for updating the list of identification numbers.
